(19) United States
(12) Patent Application Publication
(10) Pub. No.: US 2011/0096447 A1
(43) Pub. Date: Apr. 28, 2011

(54) INTEGRATED CIRCUIT DEVICE AND ELECTRONIC APPARATUS

(75) Inventors: Teppei HIGUCHI, Hara-mura (JP); Katsuhiko MAKI, Chino-shi (JP)

(73) Assignee: SEIKO EPSON CORPORATION, Tokyo (JP)

(21) Appl. No.: 12/905,328

(22) Filed: Oct. 15, 2010

(30) Foreign Application Priority Data
Oct. 22, 2009 (JP) 2009-243193
Oct. 4, 2010 (JP) 2010-224765

(51) Int. Cl. H02H 9/04

(52) U.S. Cl. 361/56

(57) ABSTRACT

An integrated circuit device includes: a pad to which a signal is input; an analog circuit performing analog processing of the signal input via the pad; and a capacitor disposed between a signal input node of the analog circuit and the pad, wherein the pad and one end of the capacitor are connected to each other with a pad wiring formed of an uppermost metal layer.

The entire disclosure of Japanese Patent Application No. 2009-243193, filed on Oct. 22, 2009 and Japanese Patent Application No. 2010-224765, filed on Oct. 4, 2010 are expressly incorporated by reference herein.

### BACKGROUND

1. Technical Field

An aspect of the present invention relates to an integrated circuit device, an electronic apparatus, and the like.

2. Related Art

In integrated circuit devices, pads which are terminals for external connection are disposed. For the pad for external connection, an electrostatic discharge protection element (ESD (electrostatic discharge) protection element) for preventing breakdown of an internal circuit due to static electricity from the outside is disposed. A related art of a semiconductor device provided with such an electrostatic discharge protection element is disclosed in, for example, JP-A-2009-49331.

In the related art disclosed in JP-A-2009-49331, a wiring from a pad to an electrostatic discharge protection element is formed of a plurality of metal layers so that a resistance value of the wiring from the pad to the electrostatic discharge protection element is smaller than a resistance value of a wiring from the electrostatic discharge protection element to an internal element of an internal circuit.

In the related art, however, a wiring formed of an uppermost metal layer, wirings formed of lower metal layers, and contacts connecting the uppermost metal layer with the lower metal layers are present on a path from the pad to the internal circuit. Accordingly, when the internal circuit is an analog circuit for example, the parasitic resistance or parasitic capacitance of these wirings and contacts may adversely affect analog processing such as amplification processing or detection processing.

### SUMMARY

An advantage of some aspects of the invention is to provide an integrated circuit device which can improve the characteristics of analog processing, an electronic apparatus, and the like.

An aspect of the invention relates to an integrated circuit device including: a pad to which a signal is input; an analog circuit performing analog processing of the signal input via the pad; and a capacitor disposed between a signal input node of the analog circuit and the pad, wherein the pad and one end of the capacitor are connected to each other with a pad wiring formed of an uppermost metal layer.

According to the aspect of the invention, the capacitor is disposed between the signal input node of the analog circuit and the pad, and the pad and one end of the capacitor are connected to each other with the pad wiring formed of the uppermost metal layer. When the pad and one end of the capacitor are connected as they are with the pad wiring of the uppermost metal layer as described above, it becomes possible to reduce the parasitic resistance or parasitic capacitance compared to a method in which the direct connection of the pad wiring is not made, thereby making it possible to improve the characteristics of analog processing or the like.

In the aspect of the invention, the integrated circuit device may be configured such that the integrated circuit device further includes an electrostatic discharge protection element for the pad, and that the pad wiring is routed so as to overlap the electrostatic discharge protection element in plan view.

When such an electrostatic discharge protection element is disposed, electrostatic discharge protection withstand voltage can be secured while improving the characteristics of analog processing or the like.

In the aspect of the invention, the integrated circuit device may be configured such that the pad wiring and the electrostatic discharge protection element are connected to each other with a contact formed in an overlapping region of the pad wiring and the electrostatic discharge protection element.

When a contact is formed in such an overlapping region, the parasitic resistance of a wiring connecting the pad with the electrostatic discharge protection element can be reduced, making it possible to secure electrostatic discharge protection withstand voltage.

In the aspect of the invention, the integrated circuit device may be configured such that the integrated circuit device further includes a first diode for electrostatic discharge protection whose anode terminal is connected to a low-potential-side power supply node; and a second diode for electrostatic discharge protection whose cathode terminal is connected to a high-potential-side power supply node, and that a cathode terminal of the first diode and an anode terminal of the second diode are connected to each other via the pad wiring.

When such first and second diodes are disposed, static electricity applied to the pad can be easily discharged to the low-potential-side power supply node or the high-potential-side power supply node.

In the aspect of the invention, the integrated circuit device may be configured such that the analog circuit includes a receiving circuit performing receive processing of the signal input via the pad, and that the capacitor is an AC coupling capacitor disposed between a signal input node of the receiving circuit and the pad.

By doing this, in the analog circuit having the receiving circuit, the characteristics of analog processing, such as receiving sensitivity, can be improved. Moreover, by effectively using an AC coupling capacitor, it is also possible to secure electrostatic discharge protection withstand voltage, for example.

In the aspect of the invention, the integrated circuit device may be configured such that the analog circuit includes a transmitting circuit performing transmit processing of a signal output via the pad, and that the pad and an output node of the transmitting circuit are connected to each other with the pad wiring.

By doing this, in the analog circuit having the receiving circuit and the transmitting circuit, the characteristics of analog processing can be improved.

In the aspect of the invention, the integrated circuit device may be configured such that the capacitor is a capacitor having an MIM (metal-insulator-metal) structure.

By doing this, a large capacitance value can be obtained with a small area, and the degradation of the characteristics of analog processing, or the like, due to the voltage dependency of capacitance value can be suppressed.

In the aspect of the invention, the integrated circuit device may be configured such that an electrode of the capacitor at one end is formed of a lower metal layer below the uppermost metal layer, and an electrode of the capacitor at the other end is formed of a metal layer for MIM formed between the uppermost metal layer and the lower metal layer.

By doing this, the parasitic capacitance, such as the fringe capacitance of the capacitor, can be reduced.

In the aspect of the invention, the integrated circuit device may be configured such that a contact connecting the electrode of the capacitor at the other end with the input node of the analog circuit is formed in a region not overlapping a forming region of the capacitor in plan view.

By doing this, it is possible to prevent the situation in which, for example, the capacitance value of the capacitor deviates from a design value or the like.

In the aspect of the invention, the integrated circuit device may be configured such that the uppermost metal layer is a metal layer having a greater thickness than a lower metal layer.

By doing this, the parasitic resistance of the pad wiring can be reduced, making it possible to improve the characteristics of analog processing, or the like.

In the aspect of the invention, the integrated circuit device may be configured such that the pad and one end of the capacitor are connected to each other not via a wiring formed of a lower metal layer below the uppermost metal layer.

By doing this, it is possible to prevent the adverse effect of the parasitic resistance of the wiring of the lower metal layer.

In the aspect of the invention, the integrated circuit device may be configured such that a shield layer disposed below the pad.

By doing this, power loss or the like of the signal input to the pad can be reduced.

Another aspect of the invention relates to an electronic apparatus including any of the integrated circuit devices described above.

### BRIEF DESCRIPTION OF THE DRAWINGS

The invention will be described with reference to the accompanying drawings, wherein like numbers reference like elements.

FIG. 1 shows a configuration example of an integrated circuit device of an embodiment.

FIG. 2 shows another configuration example of the integrated circuit device of the embodiment.

FIGS. 3A and 3B respectively show configuration examples of a low noise amplifier and a power amplifier.

FIG. 4 is a cross-sectional view illustrating a wiring method of the embodiment.

FIG. 5 is a cross-sectional view illustrating a wiring method of a comparative example.

FIG. 6 shows measurement results of bit error rate.

FIG. 7 is a cross-sectional view illustrating another example of the wiring method of the embodiment.

FIG. 8 is a cross-sectional view illustrating still another example of the wiring method of the embodiment.

FIG. 9 is a plan layout view of the integrated circuit device of the embodiment.

FIG. 10 shows a circuit configuration example of the integrated circuit device of the embodiment.

FIG. 11 shows another circuit configuration example of the integrated circuit device of the embodiment.

FIG. 12 shows a configuration example of an electronic apparatus.

### DESCRIPTION OF EXEMPLARY EMBODIMENTS

Hereinafter, a preferred embodiment of the invention will be described in detail. The embodiment described below does not unduly limit the contents of the invention set forth in the claims. Further, all the configurations described in the embodiment are not necessarily indispensable as solving means of the invention.

### 1. Configuration

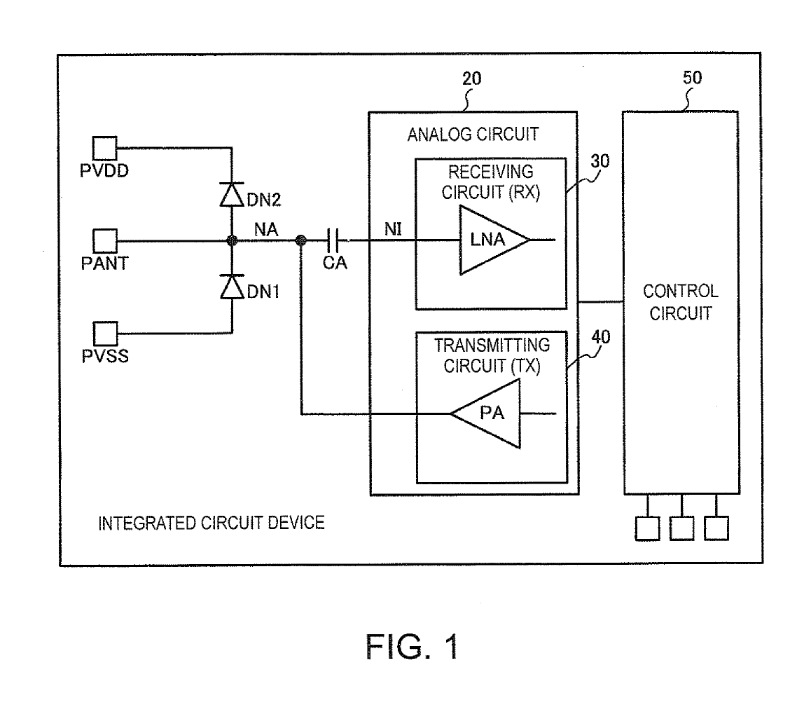

FIG. 1 shows a configuration example of an integrated circuit device of the embodiment. The integrated circuit device of the embodiment includes a pad PANT, an analog circuit 20, and a capacitor CA. The integrated circuit device can further include pads PVSS and PVDD, diodes DN1 and DN2 each serving as an electrostatic discharge protection element (ESD protection element), and a control circuit 50 (logic circuit). Here, various modifications can be made. For example, some of the constituents (for example, the electrostatic discharge protection element, the control circuit, etc.) may be omitted, or another constituent may be added.

The pad PANT is an external connection terminal to which signals are input, and for example, a bonding wire or the like is connected thereto. Taking a wireless circuit as an example, an antenna or matching circuit composed of an inductor and the like is connected to the pad PANT, and RF (radio frequency) input signals are input thereto. Alternatively, RF output signals are output therefrom. The antenna or the like may be formed on-chip using the so-called W-CSP (wafer-level chip size package) technique or the like, or may be realized by an external component of an integrated circuit device (IC chip). A high-potential-side power supply VDD and a low-potential-side power supply VSS are supplied from the outside to the pads PVDD and PVSS, respectively.

The analog circuit 20 performs analog processing of signals input via the pad PANT. Also, the analog circuit 20 may perform analog processing of signals output via the pad PANT. In this case, the analog processing includes various kinds of signal processing such as signal amplification, signal detection, or signal filtering. The analog circuit 20 can be realized by circuit elements such as an operational amplifier, an inductor, a capacitor, or a resistance.

In FIG. 1, the analog circuit 20 includes a receiving circuit (RX) 30 and a transmitting circuit (TX) 40. The receiving circuit 30 performs receive processing such as amplification or filtering, of signals input via the pad PANT. The receiving circuit 30 includes, for example, a low noise amplifier LNA (input amplifier).

The transmitting circuit 40 performs transmit processing, such as amplification or amplitude adjustment, of signals output via the pad PANT. The transmitting circuit 40 includes, for example, a power amplifier PA (output amplifier). The analog circuit 20 may be configured to include only the receiving circuit 30 without the transmitting circuit 40.

The capacitor CA is disposed between a signal input node NI of the analog circuit 20 (the receiving circuit 30) and the pad PANT. For example, one end of the capacitor CA is connected to the pad PANT, while the other end of the capacitor CA is connected to the signal input node NI of the analog circuit 20. The capacitor CA is, for example, an AC coupling (DC cutting) capacitor disposed between the signal input node NI and the pad PANT. The capacitor CA may be a capacitor for operational amplification (for example, charge/voltage converting capacitor) of an operational amplifier.

The diodes DN1 and DN2 (first and second diodes) are each a diode for electrostatic discharge protection and function as an electrostatic discharge protection element. An anode terminal (P-side terminal; P-type impurity region) of the diode DN1 is connected to a VSS node (low-potential-side power supply node in a broad sense). A VDD node (high-potential-side power supply node in a broad sense) is connected to a cathode terminal (N-side terminal; N-type impurity region) of the diode DN2. A cathode terminal of the diode DN1 and an anode terminal of the diode DN2 are connected to a node NA of the pad PANT. Specifically, the cathode terminal of the diode DN1 and the anode terminal of the diode DN2 are connected to each other via a pad wiring of the pad PANT.

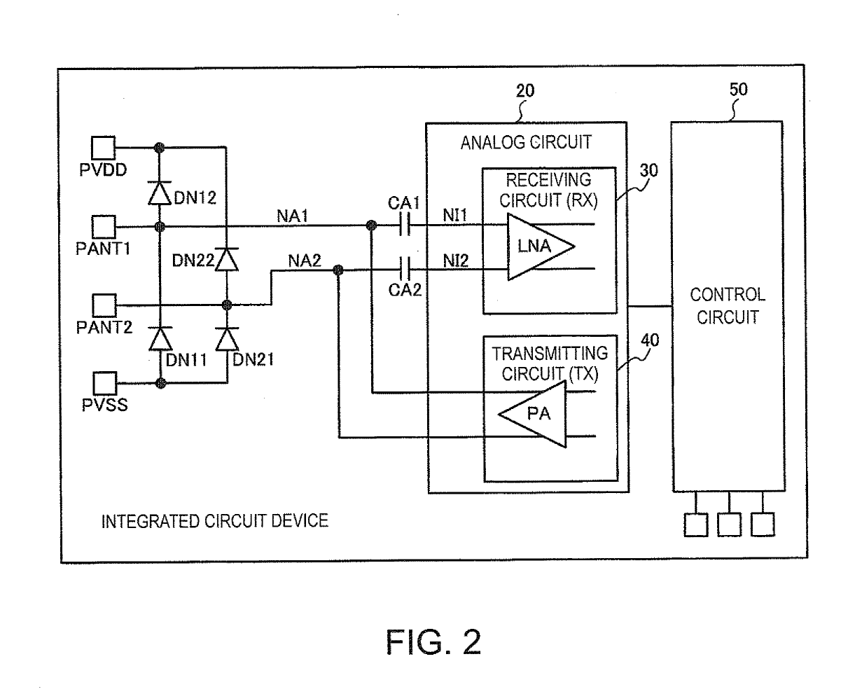

In FIG. 1, the analog circuit 20 of a single-end input type (single-end output type) has been described. As shown in FIG. 2, however, the analog circuit 20 may be of a differential input type (differential output type).

In FIG. 2 for example, a pad PANT1 on the positive side (non-inverting side) of differential signals and a pad PANT2 on the negative side (inverting side) are disposed. Between a node NA1 of the pad PANT1 and the VSS node, a diode DN11 for electrostatic discharge protection whose forward direction is from VSS to NA1 is disposed. Between the node NA1 and the VDD node, a diode DN12 for electrostatic discharge protection whose forward direction is from NA1 to VDD is disposed. Between a node NA2 of the pad PANT2 and the VSS node, a diode DN21 for electrostatic discharge protection whose forward direction is from VSS to NA2 is disposed. Between the node NA2 and the VDD node, a diode DN22 for electrostatic discharge protection whose forward direction is from NA2 to VDD is disposed.

Between the pad PANT1 and a signal input node NI1 of the analog circuit 20 (receiving circuit) on the positive side (non-inverting side), a capacitor CA1 is disposed. Between the pad PANT2 and a signal input node NI2 of the analog circuit 20 on the negative side (inverting side), a capacitor CA2 is disposed.

The low noise amplifier LNA of the receiving circuit 30 is a differential input type amplifier. The power amplifier PA of the transmitting circuit 40 is a differential output type amplifier. A positive-side input terminal (non-inverting input terminal) of the low noise amplifier LNA is connected to the node NI1 of the capacitor CA1 on the other end side, and a negative-side input terminal (inverting input terminal) thereof is connected to the node NI2 of the capacitor CA2 on the other end side. A positive-side output terminal (non-inverting output terminal) of the power amplifier PA is connected to the node NA1 of the capacitor CA1 on one end side, and a negative-side output terminal (inverting output terminal) thereof is connected to the node NA2 of the capacitor CA2 on one end side.

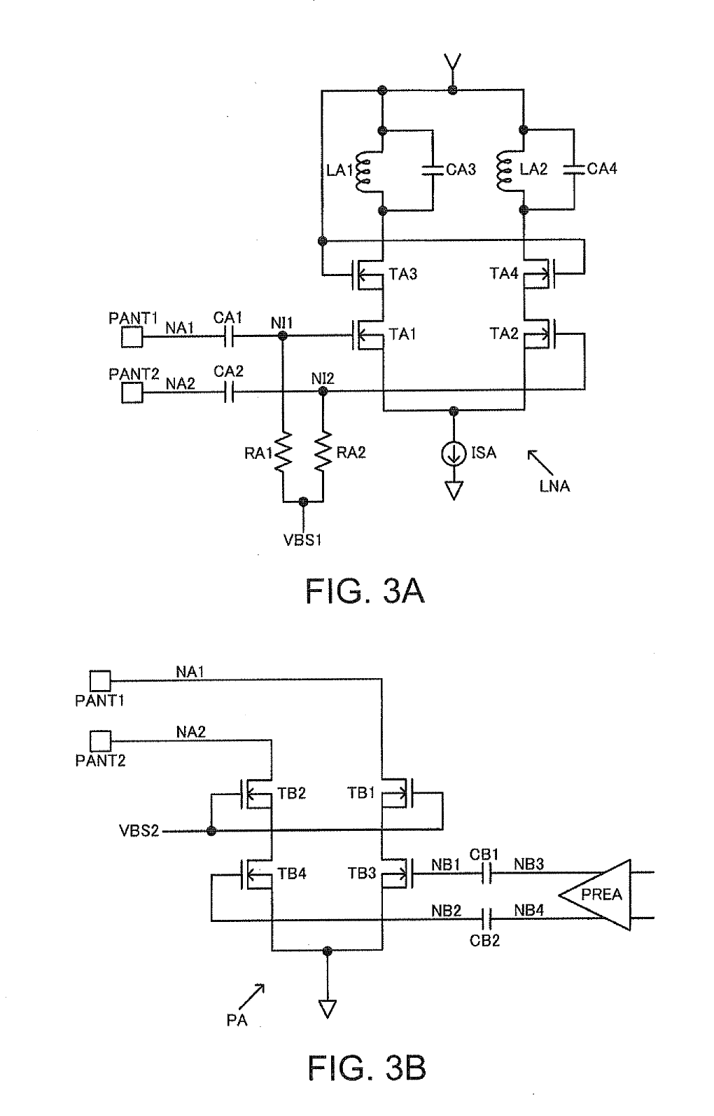

FIG. 3A shows a configuration example of the low noise amplifier LNA. The low noise amplifier LNA includes N-type (first conductivity type in a broad sense) transistors TA1, TA2, TA3, and TA4, a current source ISA, inductors LA1 and LA2, and capacitors CA3 and CA4. The low noise amplifier LNA also includes resistances RA1 and RA2.

The transistors TA1 and TA2 are differential input transistors. Gates of the transistors TA1 and TA2 are respectively connected with the nodes NI1 and NI2, and sources thereof are connected with the current source ISA. The transistors TA3 and TA4 are cascode-connected transistors for reducing the mirror effect. Gates of the transistors TA3 and TA4 are connected with, for example, the VDD node, and sources thereof are respectively connected with drains of the transistors TA1 and TA2.

The inductor LA1 and the capacitor CA3, and the inductor LA2 and the capacitor CA4 each form a load circuit constituting a resonant circuit. The resonant frequency of each of the resonant circuits is set to around the frequency of a carrier wave of a received signal. For example, when the frequency of the carrier wave is 2.4 GHz, the resonant frequency is also set to around 2.4 GHz. By disposing the load circuit of the resonant circuit, a high-frequency received signal can be amplified with low noise.

The resistances RA1 and RA2 set DC voltage of signals after AC coupling (after DC cutting) by the capacitors CA1 and CA2. DC bias voltage VBS1 is set to one ends of the resistances RA1 and RA2, and the other ends thereof are respectively connected to the nodes NI1 and NI2.

FIG. 3B shows a configuration example of the power amplifier PA. The power amplifier PA includes N-type transistors TB1, TB2, TB3, and TB4, AC coupling capacitors CB1 and CB2, and a preamplifier PREA.

Bias voltage VBS2 is set to gates of the transistors TB1 and TB2, and the nodes NA1 and NA2 are respectively connected to drains thereof. Gates of the transistors TB3 and TB4 are respectively connected with nodes NB1 and NB2 of the capacitors CB1 and CB2 at respective one ends, drains thereof are respectively connected with the transistors TB1 and TB2, and sources thereof are connected with the VSS node. Nodes NB3 and NB4 of the capacitors CB1 and CB2 at the respective other ends are connected to differential output terminals (positive side and negative side) of the preamplifier PREA.

### 2. Pad Wiring

Next, a wiring method of the embodiment will be described. In the embodiment, a method is employed in which the pad PANT (PANT1 and PANT2 in FIG. 2) and one end of the capacitor CA (CA1 and CA2 in FIG. 2) both in FIG. 1 are connected to each other with a pad wiring (wiring directly connected to the pad) formed of an uppermost metal layer (metal such as aluminum, or an alloy thereof). That is, the pad wiring from the pad PANT is directly connected to one end of the capacitor CA. For example, the pad PANT and one end of the capacitor CA are connected not via wirings formed of lower metal layers (first to N-1th metal layers) below the uppermost metal layer (Nth metal layer; N is an integer of 3 or more). A connection path of the lower metal layers may be present on a connection path between the pad PANT and one end of the capacitor CA. Also in this case in the embodiment, however, a connection path of the uppermost metal layer is definitely present.

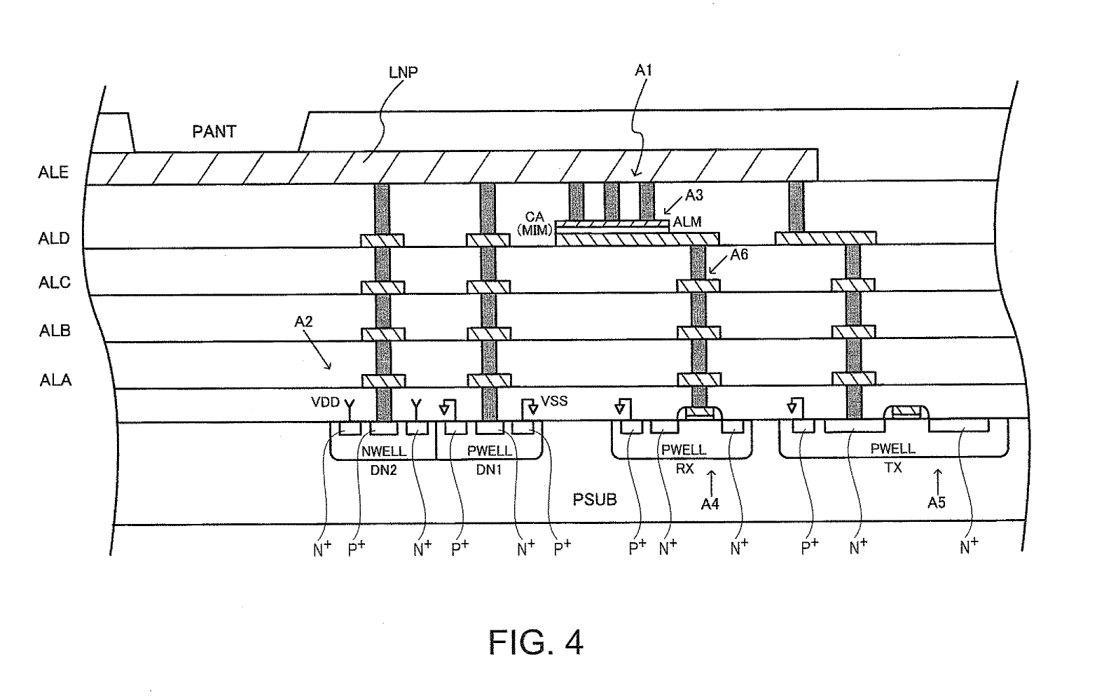

FIG. 4 shows a cross-sectional view of an integrated circuit device (semiconductor device) for illustrating the wiring method of the embodiment. As shown by A1 in FIG. 4, a pad wiring LNP from the pad PANT is routed and connected to an electrode of the capacitor CA at one end. The pad wiring LNP is formed of an uppermost metal layer ALE (fifth aluminum layer). The uppermost metal layer ALE is a metal layer having a greater thickness than lower metal layers ALA, ALB, ALC, and ALD (first to fourth aluminum layers), and for example, the thickness is 5 to 10 or more times the lower metal layers.

Specifically, the inductors LA1 and LA2 of the low noise amplifier LNA in FIG. 3A are formed by routing the uppermost metal layer ALE in, for example, a spiral shape. The uppermost metal layer ALE is formed to be a thick metal layer, whereby the sheet resistance thereof is lowered, making it possible to reduce the parasitic resistance. Thus, the Q-value of the resonant circuit formed of the inductor LA1 and the capacitor CA3, or LA2 and CA4 can be increased, whereby frequency selectivity can be improved. Because of the reason described above, a manufacturing process by which the uppermost metal layer ALE is formed to be a thicker metal layer than the lower metal layers ALA, ALB, ALC, and ALD is employed to manufacture the integrated circuit device in the embodiment.

Inductors formed of the uppermost metal layer ALE can be used not only for the low noise amplifier LNA in FIG. 3A but also for the preamplifier PREA of the power amplifier PA in FIG. 3B, or a VCO (voltage controlled oscillator) of a PLL circuit which generates clocks, for example. Inductors (inductor elements) included in the analog circuit are formed of the uppermost metal layer having a greater thickness than the lower metal layers (for example, the thickness being 5 or more times, or 10 or more times the lower metal layer), whereby the sheet resistance is lowered compared to the case where the inductor is formed of the lower metal layer (for example, the resistance value being ⅕ or less, or 1/10 or less compared to the case where the inductor is formed of the lower metal layer), making it possible to reduce the parasitic resistance of the inductor. Moreover, compared to the case where the inductor is formed of the lower metal layer, the distance between the inductor and a substrate (semiconductor substrate) can be lengthened, making it possible to reduce the parasitic capacitance of the inductor. The parasitic resistance and the parasitic capacitance are reduced in this manner, whereby the Q-value of the inductor can be increased.

In the embodiment, focusing on the fact that the uppermost metal layer ALE is a thick metal layer compared to the case where a typical manufacturing process is employed, a method of connecting the pad wiring LNP formed of the uppermost metal layer ALE as it is to the capacitor CA is employed. By doing this, the parasitic resistance or parasitic capacitance of the connection wiring from the pad PANT to the capacitor CA can be reduced, and therefore, the characteristics (performances) of analog processing of the analog circuit 20 can be improved.

For example, when the parasitic resistance of the connection wiring between the pad PANT and the capacitor CA is increased, noise caused by the parasitic resistance is increased, thereby degrading SNR. There is also a problem in that electric power of signals received by an antenna or the like is consumed by the resistance component of the parasitic resistance.

According to the embodiment, on the other hand, since the parasitic resistance of the connection wiring between the pad PANT and the capacitor CA can be reduced, the noise caused by the parasitic resistance can be reduced, thereby making it possible to improve SNR. Moreover, the situation in which the electric power of signals received by an antenna or the like is consumed by the resistance component of the parasitic resistance can be suppressed as much as possible, thereby improving receiving sensitivity or the like.

When the parasitic capacitance between the connection wiring of the pad PANT and the capacitor CA, and VSS (GND) is increased, most of the high-frequency components of received signals flow to the VSS side. Therefore, the high-frequency components of signals transmitting to the low noise amplifier LNA side via the AC coupling capacitor CA are attenuated, thereby reducing the receiving sensitivity or the like of the low noise amplifier LNA.

In this regard, according to the wiring method in FIG. 4, the pad wiring LNP is formed of the uppermost metal layer ALE having a great thickness compared to the lower metal layers. Accordingly, since the parasitic resistance of the pad wiring LNP connecting the pad PANT with the capacitor CA is reduced, the cutoff frequency of a low-pass filter of a CR circuit formed of the parasitic resistance and the parasitic capacitance becomes high. Accordingly, attenuation of the high-frequency components of signals due to the low-pass filter can be prevented, whereby the receiving sensitivity or the like of the low noise amplifier LNA can be improved.

According to the wiring method in FIG. 4, since the wiring path from the pad PANT to the capacitor CA is formed of the pad wiring LNP of the uppermost metal layer, the distance between the wiring path and a semiconductor substrate PSUB which is set to VSS can be lengthened. Accordingly, the parasitic capacitance between the wiring path and VSS can be reduced, and high-frequency components of signals flowing to the VSS side can be reduced, whereby the receiving sensitivity or the like of the low noise amplifier LNA can be improved.

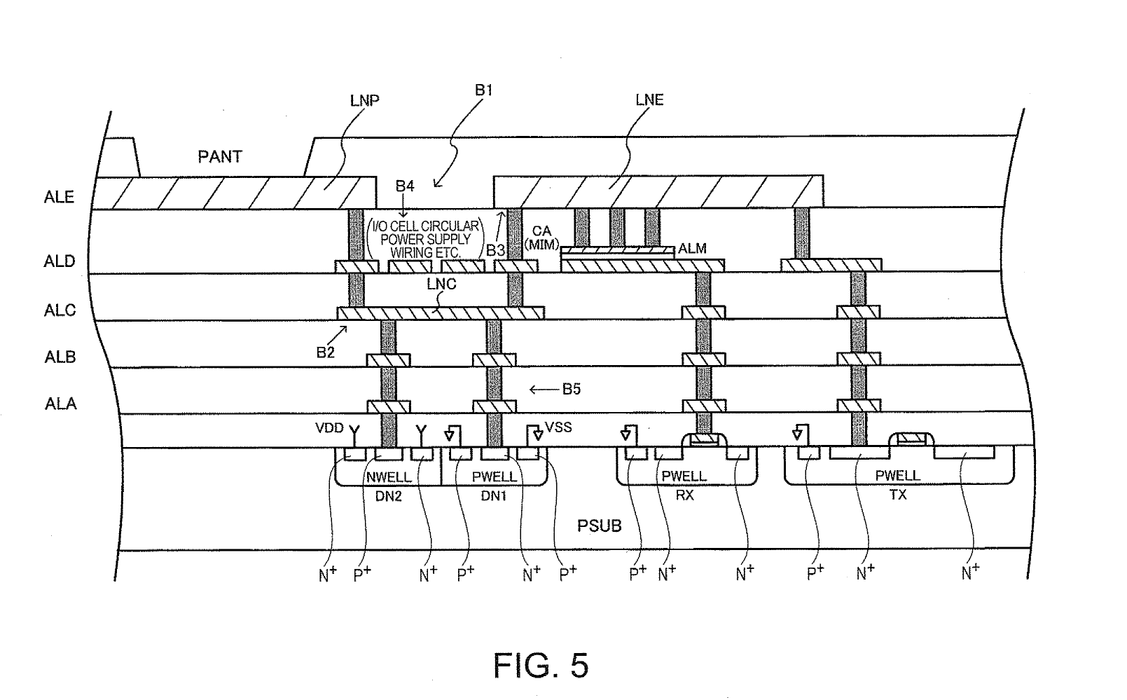

For example, FIG. 5 shows a cross-sectional view illustrating a wiring method of a comparative example. In the wiring method of the comparative example as shown by B1, the pad wiring LNP from the pad PANT is not directly connected to the capacitor CA. Specifically, the pad wiring LNP is connected to a wiring LNC of the lower metal layer ALC via contacts (vias) as shown by B2, and thereafter connected to a wiring LNE of the uppermost metal layer ALE via contacts as shown by B3. Then, the wiring LNE is connected to one end of the capacitor CA. By doing this, a signal wiring which does not intersect with a circular power supply wiring of an I/O cell and the like shown by B4 is realized.

In the method of the comparative example in FIG. 5 as described above, the pad PANT and one end of the capacitor CA are connected to each other via the wiring LNC formed of the lower metal layer. In the embodiment in FIG. 4, on the other hand, the pad PANT and one end of the capacitor CA are connected to each other not via the wiring LNC formed of the lower metal layer but only with the pad wiring LNP formed of the uppermost metal layer ALE.

Also in the method of the comparative example in FIG. 5, the wiring LNC of the lower metal layer ALC is connected to the cathode terminal (N-type impurity region) of the diode DN1 for electrostatic discharge protection and the anode terminal (P-type impurity region) of the diode DN2 via contacts.

That is, in a wiring method in the past like the comparative example in FIG. 5, the pad wiring LNP is not directly connected to an internal circuit, but a method is employed in which the pad wiring LNP is first connected to the diodes DN1 and DN2 for electrostatic discharge protection via the wiring LNC of the lower metal layer ALC, and thereafter connected to the internal circuit. This is because it is considered that since static electricity from the pad PANT is first transmitted to the diodes DN1 and DN2 to flow to the VSS side or the VDD side and then transmitted to the internal circuit at a later time, the ESD withstand voltage can be improved.

In the method in FIG. 5, however, the wiring LNC formed of the lower metal layer ALC is present on the wiring path between the pad PANT and the capacitor CA as shown by B2. Since the thickness of the lower metal layer ALC is small, and the sheet resistance of the wiring LNC is high, the parasitic resistance of the wiring path between the pad PANT and the capacitor CA is increased compared to that of FIG. 4. Further, since the parasitic resistances of the contacts connecting the pad wiring LNP with the wiring LNC or the contacts connecting the wiring LNC with the wiring LNE are also added, the parasitic resistance of the wiring path between the pad PANT and the capacitor CA is further increased. Therefore, the parasitic resistance causes degradation of the receiving sensitivity or the like of the receiving circuit.

Also in FIG. 5, since the wiring LNC is formed of the lower metal layer ALC whose distance from the substrate PSUB is short, the parasitic capacitance between the wiring LNC and VSS is increased compared to the case where the pad wiring LNP is directly connected as shown in FIG. 4, increasing the high-frequency components of the signals flowing to the VSS side. Also as shown by B4, since the circular power supply wiring of the I/O cell is present above the wiring LNC, the parasitic capacitance between the wiring LNC and the power supply wiring is also formed, increasing high-frequency components of signals flowing to the circular power supply wiring side.

According to the method of the embodiment in FIG. 4, on the other hand, the pad wiring LNP is formed of the thick uppermost metal layer ALE, and the lower metal layer ALC or the contacts for connecting with the lower metal layer ALC are not present on the wiring path between the pad PANT and the capacitor CA. Accordingly, the parasitic resistance can be reduced compared to FIG. 5. Moreover, since the pad wiring LNP is formed of the uppermost metal layer ALE, the distance from the substrate PSUB can be lengthened compared to FIG. 5, and the parasitic capacitance can also be reduced. Therefore, the receiving sensitivity or the like can be improved compared to FIG. 5.

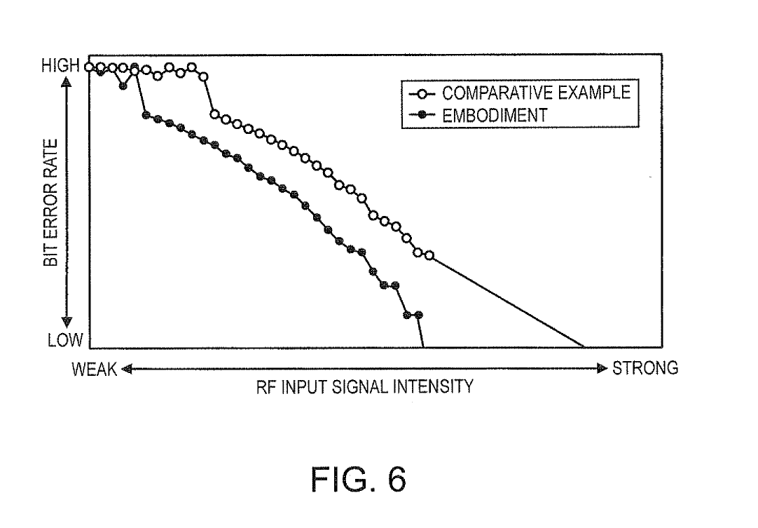

For example, FIG. 6 shows measurement results showing the relationship of bit error rate relative to RF input signal intensity. In FIG. 6, black circles are measurement results when the method of the embodiment in FIG. 4 is employed, while white circles are measurement results when the method of the comparative example in FIG. 5 is employed. As shown in FIG. 6, bit error rate can be greatly reduced according to the embodiment compared to the comparative example. For example, an improvement of about 3 decibels in receiving sensitivity can be realized.

In the embodiment as shown in FIG. 4, the diodes DN1 and DN2 each of which is an electrostatic discharge protection element for the pad PANT are disposed. The pad wiring LNP is routed so as to overlap the diodes DN1 and DN2 (electrostatic discharge protection elements in a broad sense) in plan view. With contacts formed in the overlapping region of the pad wiring LNP and the diodes DN1 and DN2 for electrostatic discharge protection, the pad wiring LNP and the diodes DN1 and DN2 are connected as shown by A2 in FIG. 4. Specifically, the cathode terminal of the diode DN1 and the anode terminal of the diode DN2 are connected via the pad wiring LNP.

By doing this, static electricity applied to the pad PANT is discharged to the VSS side or the VDD side via the diode DN1 or DN2, whereby electrostatic discharge protection withstand voltage can be secured.

In the embodiment in this case, the AC coupling capacitor CA is present between the gate of the transistor (TA1 and TA2 in FIG. 3A) constituting the receiving circuit 30 (RX) shown by A4 in FIG. 4 and the pad wiring LNP. Accordingly, even when static electricity is applied to the pad PANT, it is possible to prevent the situation in which the gate or the like of the transistor shown by A4 is broken due to the static electricity. Also focusing on this point, the embodiment employs the method of directly connecting the pad wiring LNP.

In FIG. 3A, the resistances RA1 and RA2 for setting DC voltage of signals after AC coupling are respectively connected to one ends of the capacitors CA1 and CA2. Accordingly, the capacitor CA1 and the resistance RA1, or the capacitor CA2 and the resistance RA2 constitute a high-pass filter. It is considered that frequency components of static electricity (human body model and machine model) exist in a low frequency band relative to the cutoff frequency of each of the high-pass filters. Accordingly, due to also the attenuation effect of these high-pass filters, it is possible to protect the transistors to thereby prevent electrostatic breakdown of the transistors. Since especially the frequency of an RF signal is high, the cutoff frequency of the high-pass filter composed of CA1 and RA1, or CA2 and RA2 can be set to a high frequency. Accordingly, the prevention of electrostatic breakdown can be further expected due to the attenuation effect of the high-pass filter.

In FIG. 4, the pad wiring LNP is also connected to the drain of the transistor constituting the transmitting circuit 40 (TX) shown by A5. Since the transistor shown by A5 is a transistor for the power amplifier PA, the transistor size is generally large. Accordingly, since the static electricity applied to the pad PANT is discharged to the VSS side or the VDD side due to also the diode formed at the drain of the transistor shown by A5, electrostatic discharge protection withstand voltage can be secured even when the method of directly connecting the pad wiring LNP is employed.

When electrostatic discharge protection withstand voltage can be sufficiently secured due to the capacitor CA or the transistors shown by A5, a modification in which the diodes DN1 and DN2 each serving as an electrostatic discharge protection element are not disposed is also possible.

As shown by A3, the capacitor CA is a capacitor having an MIM (metal-insulator-metal) structure. Specifically, an electrode of the capacitor CA at one end is formed of the lower metal layer ALD below the uppermost metal layer ALE. An electrode of the capacitor CA at the other end is formed of a metal layer ALM for MIM formed between the uppermost metal layer ALE and the lower metal layer ALD.

When the capacitor CA having the MIM structure described above is employed, the thickness of an insulating film (dielectric material; oxide film) can be reduced, and therefore, a large capacitance value can be obtained with a small layout area. Since the capacitor CA having the MIM structure has little voltage dependency, the degradation of the analog characteristics of the analog circuit 20 can also be suppressed.

At A3 in FIG. 4, the electrode of the capacitor CA at the other end is formed of the metal layer ALD which is a layer next to the uppermost metal layer ALE. Accordingly, the distance between the capacitor CA and the substrate PSUB can be lengthened, and the fringe capacitance (parasitic capacitance between the fringe of CA and PSUB) of the capacitor CA can also be reduced. Accordingly, the high-frequency components of signals flowing to the VSS side can be reduced, whereby the receiving sensitivity or the like can be improved.

As shown by A6 in FIG. 4, a contact connecting the electrode (ALD) of the capacitor CA at the other end with the input node NI (gate of the transistor shown by A4) of the analog circuit 20 is formed in a region not overlapping the forming region of the capacitor CA. The contact shown by A6 is not formed below the capacitor CA having the MIM structure, whereby it is possible to prevent, for example, the situation in which the capacitance value of the capacitor CA deviates from a design value (simulation value).

At A3 in FIG. 4, the pad wiring LNP and the electrode (ALM) at one end of the capacitor CA having the MIM structure are desirably connected with a contact having, for example, a tungsten plug structure. By doing this, the parasitic resistance of the contact can be reduced, and the degradation of the receiving sensitivity or the like can be suppressed. Moreover, the capacitor CA can be formed of structures other than MIM. For example, the capacitor CA may be formed of a capacitor having a structure with a first-layer polysilicon and a second-layer polysilicon.

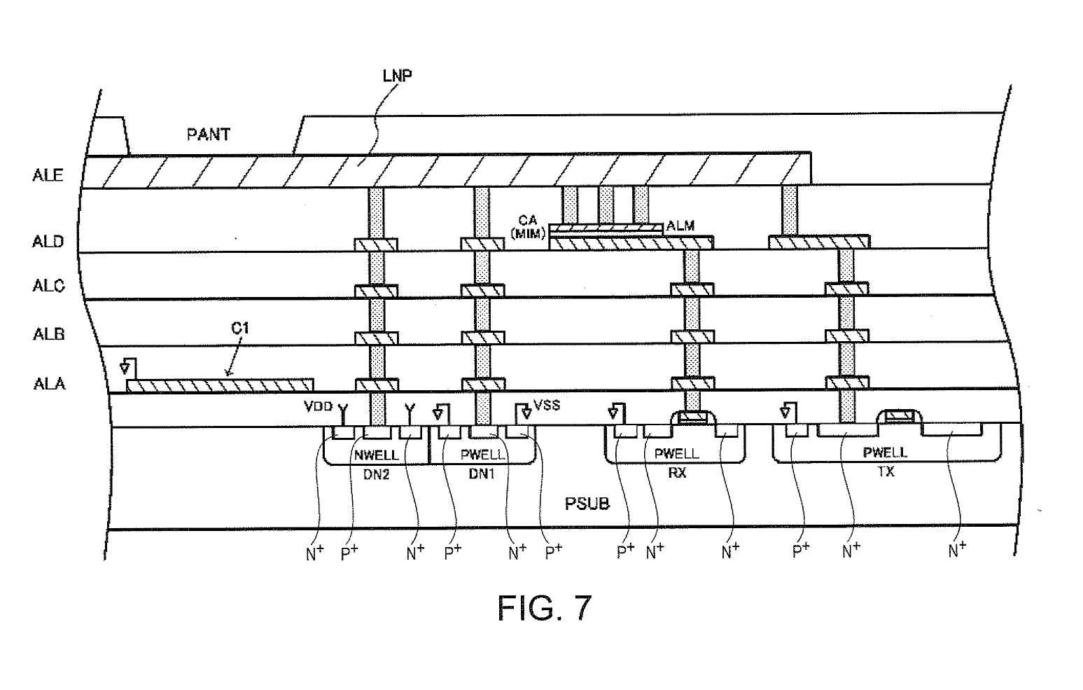

In the embodiment, a shield layer may be disposed below the pad PANT. At C1 in FIG. 7 for example, a shield layer formed of the lower metal layer ALA (first metal layer; first aluminum layer) is disposed below the pad PANT. The shield layer of ALA is connected to VSS, for example. When such a shield layer is disposed, power loss of input signals from the pad PANT can be reduced, for example. Especially when the lowermost metal layer ALA is used as a shield layer, the distance between the pad PANT and the shield layer can be lengthened. Therefore, the parasitic capacitance between the pad wiring LNP and VSS can be suppressed to the minimum.

The shield layer is not limited to the lowermost metal layer ALA, and may be formed of any of the metal layers above ALA. Alternatively, the shield layer may be formed of silicided polysilicon of low resistance or a diffusion layer.

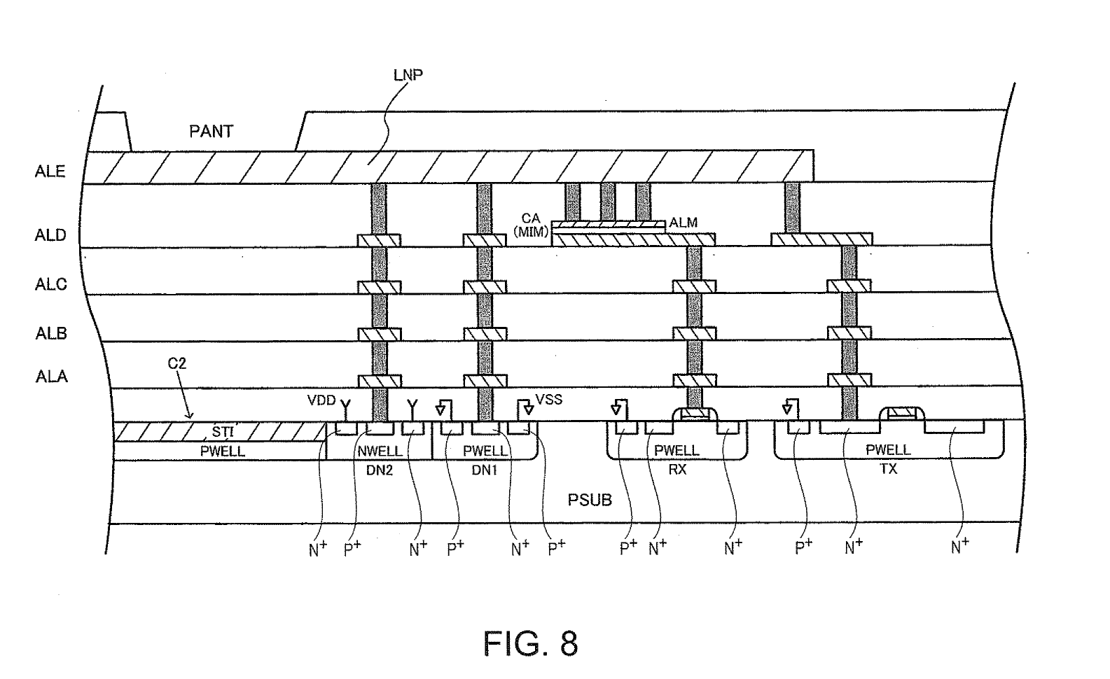

As shown by C2 in FIG. 8, an STI (shallow trench isolation) may be formed below the pad PANT. That is, the lower metal layers ALD, ALC, ALB, and ALA below the uppermost metal layer ALE are not formed below the pad PANT, but a P-type well is formed on the substrate PSUB, and an insulating film of an STI structure is formed on the P-type well. For example, a trench is formed in the P-type well (substrate), and a silicon oxide film is buried in the trench, thereby forming the STI.

When the STI is formed below the pad PANT as described above, the distance between the pad wiring LNP and the substrate PSUB can be lengthened by the amount corresponding to the thickness of the STI, making it possible to further reduce the parasitic capacitance between the pad wiring LNP and VSS. Moreover, since the lower metal layers below the pad wiring LNP are not formed below the pad PANT, it is possible to prevent, for example, the situation in which unnecessary parasitic capacitance or the like is formed.

The STI may be formed not only below the pad PANT but also, for example, in an empty space below the capacitor CA. By doing this, the fringe capacitance of the capacitor CA can be reduced, and the parasitic capacitance can be reduced.

The method in which the STI is disposed below the pad PANT while the lower metal layers are not disposed as shown in FIG. 8 has an advantage that can reduce the parasitic capacitance relative to VSS compared to the method of disposing the lower metal layer ALA below the pad PANT as shown in FIG. 7. In the method in FIG. 8, on the other hand, input signals of the pad PANT pass to the VSS side via the P-well (or P-substrate) below the STI. Since the P-well (or P-substrate) has a higher resistance than metal, there is a problem in that the resistance causes the power loss of the input signals. In the method in FIG. 7, on the other hand, since the input signals pass to the VSS side via the metal wiring of ALA having low resistance, there is an advantage that can reduce the power loss of the input signals caused by the resistance compared to the method in FIG. 8.

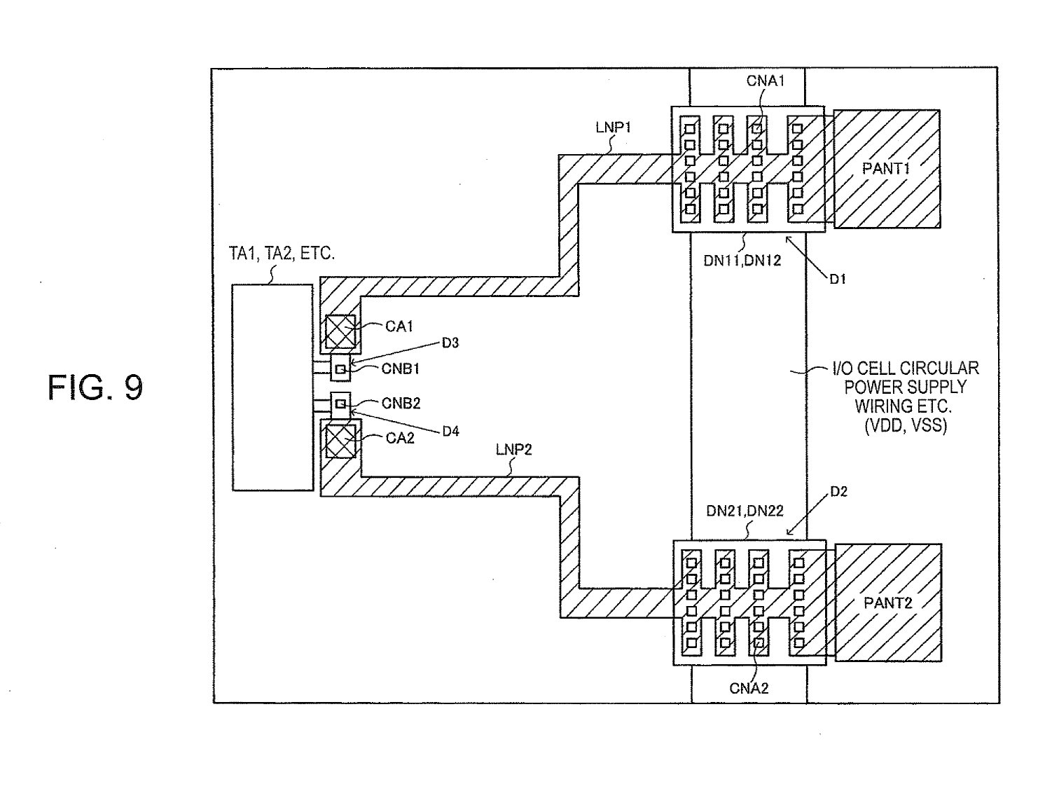

FIG. 9 shows an exemplary plan layout view (as viewed in plan) of the integrated circuit device of the embodiment. As shown in FIG. 9, pad wirings LNP1 and LNP2 from the differential pads PANT1 and PANT2 are directly connected to the capacitors CA1 and CA2 not via other wiring layers. By doing this, the parasitic resistance or parasitic capacitance can be reduced.

As shown by D1 and D2 in FIG. 9, the pad wirings LNP1 and LNP2 are routed so as to overlap the electrostatic discharge protection elements (DN11, DN12, DN21, and DN22) in plan view. That is, the layout arrangement is made so that at least a part of each of the electrostatic discharge protection elements overlaps the pad wiring LNP1 or LNP2. With contacts CNA1 and CNA2 or the like formed in the overlapping region of the pad wirings LNP1 and LNP2 and the electrostatic discharge protection elements (DN11, DN12, DN21, and DN22), the pad wirings LNP1 and LNP2 and the electrostatic discharge protection elements are connected to each other. By doing this, static electricity from the pads PANT1 and PANT2 is easily discharged to the VSS side or the VDD side via the electrostatic discharge protection elements, whereby electrostatic discharge protection withstand voltage can be improved.

As shown by D3 and D4 in FIG. 9, contacts CNB1 and CNB2 connecting electrodes of the capacitors CA1 and CA2 at the respective other ends with the input nodes NI of the analog circuit 20 are formed in a region not overlapping the forming region of the capacitors CA1 and CA2 each having the MIM structure in plan view. Thus, it is possible to prevent the situation in which, for example, the capacitance value of the capacitor CA deviates from a design value because of the presence of the contacts CNB1 and CNB2.

### 3. Circuit Configuration Example

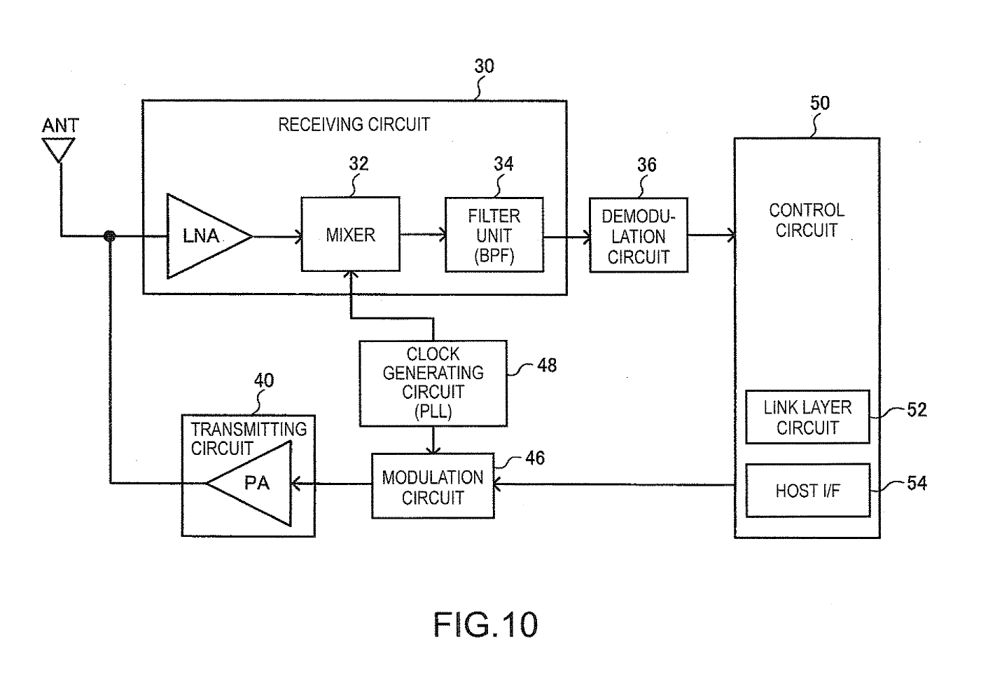

Next, a detailed circuit configuration example of the integrated circuit device of the embodiment will be described. FIG. 10 is a circuit configuration example when the integrated circuit device is an RF wireless communication circuit IC. The integrated circuit device includes the receiving circuit 30, a demodulation circuit 36, the transmitting circuit 40, a modulation circuit 46, a clock generating circuit 48, and the control circuit 50.

The receiving circuit 30 includes the low noise amplifier LNA, a mixer 32, and a filter unit 34. The low noise amplifier LNA performs processing of amplifying an RF received signal input from an antenna ANT with low noise. The mixer 32 performs mixing processing of the amplified received signal and a local signal (local frequency signal) from the clock generating circuit 50 and performs down conversion. The filter unit 34 performs filter processing of the down-converted received signal. Specifically, the filter unit 34 performs band-pass filter processing realized by a complex filter or the like to extract a baseband signal while performing image removing.

The demodulation circuit 36 performs demodulation processing based on signals from the receiving circuit 30. For example, the demodulation circuit 36 performs demodulation processing of signals which are FSK (frequency-shift keying)-modulated on the transmission side and outputs the demodulated received signals to the control circuit 50.

The modulation circuit 46 performs modulation processing of transmitted signals from the control circuit 50. For example, the modulation circuit 46 FSK-modulates transmitted signals and outputs the modulated transmitted signals to the transmitting circuit 40. The transmitting circuit 40 outputs the transmitted signals amplified by the power amplifier PA to the antenna ANT.

The clock generating circuit 48 has a PLL circuit composed of a VCO and the like and generates local signals and the like.

The control circuit 50 controls the entire integrated circuit device and executes baseband digital processing or the like. Moreover, the control circuit 50 has, for example, a link layer circuit 52 and a host I/F (interface) 54, and executes protocol processing of a link layer, interface processing with an external host, or the like.

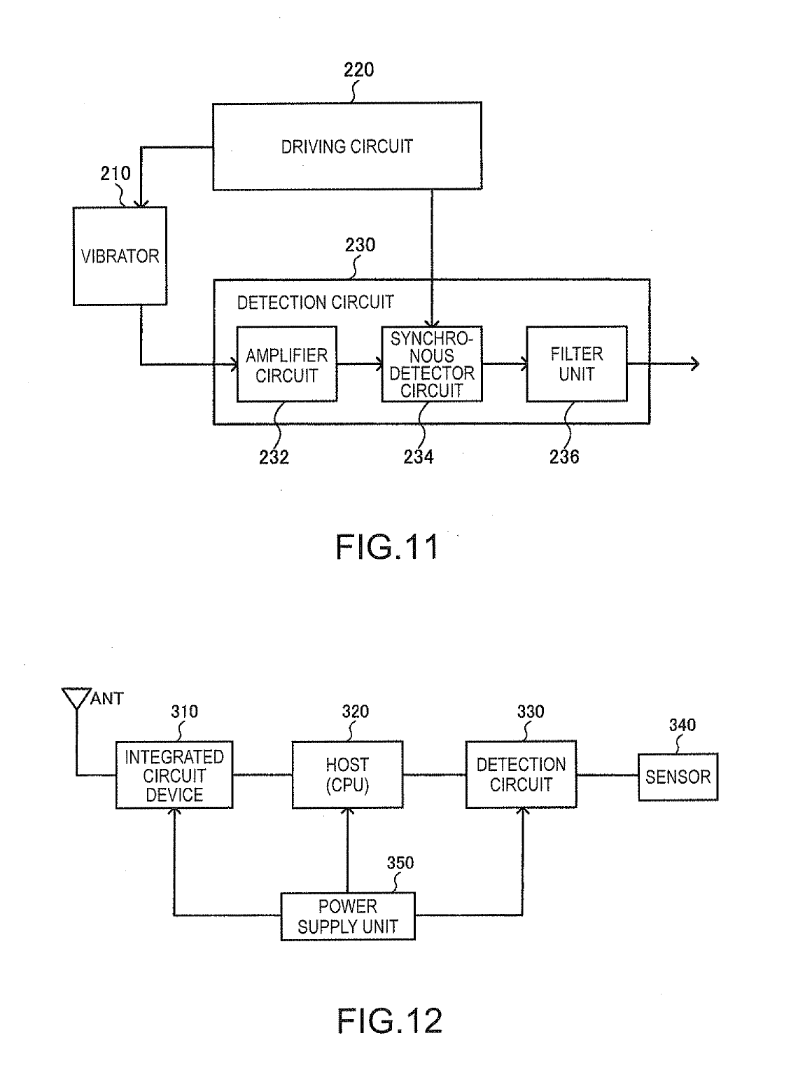

In FIGS. 1, 2, and the like, although the analog circuit of the integrated circuit device has been described mainly as an RF wireless circuit by way of example, the embodiment is not limited thereto. For example, FIG. 11 shows another configuration example of the analog circuit.

FIG. 11 shows an example where the analog circuit is a circuit which detects a physical quantity such as angular velocity information or acceleration information using a vibrator 210 (physical quantity transducer). The analog circuit in FIG. 11 includes a driving circuit 220 which outputs drive signals for the vibrator 210 to drive the vibrator 210, and a detection circuit 230 which detects a desired signal from feedback signals from the vibrator 210 to detect a physical quantity such as angular velocity information or acceleration information.

For example, taking a gyro sensor as an example, the vibrator 210 is a piezoelectric vibrator or the like formed of a piezoelectric material such as crystal. The driving circuit 220 outputs drive signals to excite the vibrator 210. The detection circuit 230 detects a desired signal such as the Coriolis force signal from detected signals (feedback signals) from the vibrator 210.

The detection circuit 230 includes an amplifier circuit 232, a synchronous detector circuit 234, and a filter unit 236. The amplifier circuit 232 performs amplification processing of the detected signals from the vibrator 210. The amplifier circuit 232 may be realized by a charge/voltage conversion circuit or the like, for example. The synchronous detector circuit 234 performs synchronous detection using the amplified detected signal and a synchronous detecting signal (reference signal) from the driving circuit 220. The filter unit 236 performs filter processing (for example, low-pass filter processing) of the signal after synchronous detection.

In FIG. 11 for example, when the amplifier circuit 232 is provided with an AC coupling capacitor or an operational amplifying (Q/V converting) capacitor, the method of the embodiment described with reference to FIG. 1 and the like can be employed.

### 4. Electronic Apparatus

FIG. 12 shows a configuration example of an electronic apparatus including an integrated circuit device 310 of the embodiment. The electronic apparatus includes the antenna ANT, the integrated circuit device 310, a host 320, a detection device 330, a sensor 340, and a power supply unit 350. The configuration of the electronic apparatus of the embodiment is not limited to that in FIG. 12, but various modifications can be made. For example, some of the constituents (for example, the detection device, the sensor, the power supply unit, etc.) may be omitted, or another constituent (for example, an operation unit or an output unit) may be added.

The integrated circuit device 310 is a wireless circuit device realized by the circuit configuration shown in FIG. 10 and performs receive processing of signals from the antenna ANT or transmit processing of signals to the antenna ANT. The host 320 controls the entire electronic apparatus or controls the integrated circuit device 310 or the detection device 330. The detection device 330 performs various kinds of detection processing (detection processing of a physical quantity) based on sensor signals from the sensor 340 (physical quantity transducer). For example, the detection device 330 performs processing of detecting a desired signal from the sensor signals and outputs A/D converted digital data to the host 320. The sensor 340 is, for example, a smoke sensor, a photosensor, a human sensor, a pressure sensor, a biosensor, a gyro sensor, or the like. The power supply unit 350 supplies power to the integrated circuit device 310, the host 320, the detection device 330 and the like, and supplies power through, for example, a dry cell (button cell etc.), a battery, or the like.

The embodiment has been described above in detail. However, those skilled in the art should readily understand that many modifications can be made without substantially departing from the novel feature and effects of the invention. Accordingly, those modified examples are also included in the scope of the invention. For example, any term (diode, VSS node, VDD node, etc.) cited with a different term (electrostatic discharge protection element, low-potential-side power supply node, high-potential-side power supply node, etc.) having a broader meaning or the same meaning at least once in the specification and the drawings can be replaced by the different term in any place in the specification and the drawings. The configurations and operations of the integrated circuit device and the electronic apparatus are not limited to those described in the embodiment, and various modifications can be made.

What is claimed is:

1. An integrated circuit device comprising:
a pad to which a signal is input;
an analog circuit performing analog processing of the signal input via the pad; and
a capacitor disposed between a signal input node of the analog circuit and the pad, wherein
the pad and one end of the capacitor are connected to each other with a pad wiring formed of an uppermost metal layer.

2. The integrated circuit device according to claim 1, further comprising an electrostatic discharge protection element for the pad, wherein
the pad wiring is routed so as to overlap the electrostatic discharge protection element in plan view.

3. The integrated circuit device according to claim 2, wherein
the pad wiring and the electrostatic discharge protection element are connected to each other with a contact formed in an overlapping region of the pad wiring and the electrostatic discharge protection element.

4. The integrated circuit device according to claim 1, further comprising:
a first diode for electrostatic discharge protection whose anode terminal is connected to a low-potential-side power supply node; and
a second diode for electrostatic discharge protection whose cathode terminal is connected to a high-potential-side power supply node, wherein
a cathode terminal of the first diode and an anode terminal of the second diode are connected to each other via the pad wiring.

5. The integrated circuit device according to claim 1, wherein
the analog circuit includes a receiving circuit performing receive processing of the signal input via the pad, and
the capacitor is an AC coupling capacitor disposed between a signal input node of the receiving circuit and the pad.

6. The integrated circuit device according to claim 5, wherein
the analog circuit includes a transmitting circuit performing transmit processing of a signal output via the pad, and
the pad and an output node of the transmitting circuit are connected to each other with the pad wiring.

7. The integrated circuit device according to claim 1, wherein
the capacitor is a capacitor having an MIM (metal-insulator-metal) structure.

8. The integrated circuit device according to claim 7, wherein
an electrode of the capacitor at one end is formed of a lower metal layer below the uppermost metal layer, and an electrode of the capacitor at the other end is formed of a metal layer for MIM formed between the uppermost metal layer and the lower metal layer.

9. The integrated circuit device according to claim 8, wherein
a contact connecting the electrode of the capacitor at the other end with the input node of the analog circuit is formed in a region not overlapping a forming region of the capacitor in plan view.

10. The integrated circuit device according to claim 1, wherein
the uppermost metal layer is a metal layer having a greater thickness than a lower metal layer.

11. The integrated circuit device according to claim 1, wherein
the pad and one end of the capacitor are connected to each other not via a wiring formed of a lower metal layer below the uppermost metal layer.

12. The integrated circuit device according to claim 1, wherein
a shield layer is disposed below the pad.

13. An electronic apparatus comprising the integrated circuit device according to claim 1.
